(19) United States
(12) Patent Application Publication
(10) Pub. No.: US 2026/0087068 A1
(43) Pub. Date: Mar. 26, 2026

(54) TAG DISTRIBUTION VISUALIZATION SYSTEM

(71) Applicant: Snap Inc., Santa Monica, CA (US)

(72) Inventors: Xuan Huang, Redmond, WA (US); Andrew Maxwell, Los Angeles, CA (US); Shuai Tong, Los Angeles, CA (US); Xiaoyu Wang, Playa Vista, CA (US)

(21) Appl. No.: 19/407,935

(22) Filed: Dec. 3, 2025

Related U.S. Application Data
(63) Continuation of application No. 18/633,132, filed on Apr. 11, 2024, now Pat. No. 12,524,457.
Application No. 18/633,132 is a continuation of application No. 17/936,277, filed on Sep. 28, 2022, now Pat. No. 11,983,215.
Application No. 17/936,277 is a continuation of application No. 16/810,254, filed on Mar. 5, 2020, now Pat. No. 11,487,794.
Application No. 16/810,254 is a continuation of application No. 15/860,847, filed on Jan. 3, 2018, now Pat. No. 10,678,818.

(51) Int. Cl. G06F 16/487; G06F 16/29; G06F 16/48; G06V 10/20; G06V 10/25; G06V 10/44

(52) U.S. Cl. CPC G06F 16/487; G06F 16/29; G06F 16/489; G06V 10/25; G06V 10/255; G06V 10/44

(57) ABSTRACT

In various embodiments described herein, a visualization system receives message requests from client devices, wherein the message requests comprise at least location data that identifies a location of a client device, and media content, wherein the media content includes at least one of image data, audio data, and video data. In response to receiving the message requests that comprise the media content, the visualization system analyzes and parses the media content to detect one or more tags embedded within the media content. In response to detecting the tag, the visualization system identifies a campaign or account referenced by or associated with the tag.

Based on the identification of the campaign based on the tag within the media content, the visualization system determines a distribution of the campaign based on the location data from the message request.

### CLAIM FOR PRIORITY

This application is a continuation of and claims the benefit of priority of U.S. application Ser. No. 18/633,132, filed Apr. 11, 2024, which is a continuation of and claims the benefit of priority of U.S. application Ser. No. 17/936,277, filed Sep. 28, 2022, which application is a continuation of and claims the benefit of priority of U.S. application Ser. No. 16/810,254, filed Mar. 5, 2020, which application is a continuation of and claims the benefit of priority of U.S. application Ser. No. 15/860,847, filed Jan. 3, 2018, all of which are hereby incorporated by reference in their entireties.

### TECHNICAL FIELD

Embodiments of the present disclosure relate generally to systems for data visualization and presentation.

### BACKGROUND

A choropleth map, often referred to as a heat map, is a graphical representation of data where the individual values contained in a matrix are visually distinguished from one another based on a color or pattern, and in which areas of a map may be shaded or patterned based on the individual values. Heatmaps therefore provide a clear method for visualizing how a measurement may vary across a geographic region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram showing an example messaging system for exchanging data (e.g., messages and associated content) over a network in accordance with some embodiments, wherein the messaging system includes a visualization system.

FIG. 2 is block diagram illustrating further details regarding a messaging system, according to example embodiments.

FIG. 3 is a diagram illustrating tags identified in media content identified by a visualization system, according to certain example embodiments.

FIG. 4 is a visualization of a distribution of a campaign as presented by a visualization system, according to certain example embodiments.

FIG. 5 is a visualization of a geographic and a temporal distribution of a campaign as presented by a visualization system, according to certain example embodiments.

FIG. 6 is a block diagram illustrating various modules of a visualization system, according to certain example embodiments.

FIG. 7 is a flowchart illustrating various operations of a visualization system in performing a method for generating and presenting a visualization of a distribution of a campaign, according to certain example embodiments.

FIG. 8 is a flowchart illustrating various operations of a visualization system in performing a method for identifying a campaign associated with a tag, according to certain example embodiments.

FIG. 9 is a flowchart illustrating various operations of a visualization system in performing a method for adjusting a visualization of a distribution, according to certain example embodiments.

FIG. 10 is a block diagram illustrating a representative software architecture, which may be used in conjunction with various hardware architectures herein described and used to implement various embodiments.

FIG. 11 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Embodiments of the present disclosure relate generally to systems for the visualization of data, and more specifically, for the visualization of a distribution of message requests that contain a tag, wherein the tag includes a reference to an account or campaign. A campaign may include a unique tag that may be identified within media content. For example, a publisher or distributor of a campaign may generate a tag that comprises a graphical icon, and assign the graphical icon to the campaign. In various embodiments described herein, a visualization system receives message requests from client devices, wherein the message requests comprise at least location data that identifies a location of a client device, and media content, wherein the media content includes at least one of image data, audio data, and video data. In response to receiving the message requests that comprise the media content, the visualization system analyzes and parses the media content to detect one or more tags embedded within the media content. For example, the visualization system may perform various object or pattern recognition techniques to identify the tags within the media content. In response to detecting the tag, the visualization system identifies a campaign or account referenced by or associated with the tag. Based on the identification of the campaign based on the tag within the media content, the visualization system determines a distribution of the campaign based on the location data from the message request.

In some embodiments, the visualization of the distribution of the campaign generated and displayed by the visualization system may include a choropleth map, or “heat map,” which depicts a distribution of values representing message requests that include media content that contains one or more tags associated with a campaign or account across a geographic area by presenting a colored, shaded, or patterned progression over a map image depicting a geographic area. The progression may include single-hue progressions, bi-polar progressions, complementary hue progressions, blended hue progressions, partial spectral hue progressions, full spectral hue progressions, value progression maps, as well as patterned progression maps.

In some embodiments, the visualization system generates and maintains geo-fences based on the distribution determined based on the message requests. For example, the visualization system may generate and maintain a geo-fence that encompasses a location in response to receiving a message request that includes media content that contains a tag associated with a campaign. The geo-fence may thereby be assigned to the campaign, such that the visualization system may track and analyze message requests originating from within the geo-fence to identify tags associated with the campaign.

In some embodiments, the message requests may include timestamps that indicate a time and date in which the message requests were generated. The visualization system may analyze the timestamps to generate and present a temporal distribution of a campaign. For example, the temporal distribution of the campaign may include a series of bar graphs, or a heat map, wherein the temporal distribution provides an indication of a moment-to-moment (e.g., day-to-day, hour-to-hour, etc.) distribution of message requests that include the tag.

Consider an illustrative example from the perspective of a publisher managing a campaign. The publisher may identify one or more tags from a campaign managed by the publisher to the visualization system, wherein the tags include images, logos, hashtags, or other similar graphical elements or auditory tones. Tags may for example include logos or other graphical identifiers associated with a publisher or user account (e.g., Nike swoosh, Chevrolet Bowtie, etc.). In response, the visualization system assigns those tags to an account associated with the campaign of the publisher.

A user of a client device may capture or generate media content to be assigned to a message request that includes a tag from among the one or more tags identified by the publisher. For example, the user may take a photo or video that includes a depiction of the tag (e.g., a photo of a billboard that includes a company logo).

The user may thereby request to distribute the media content to one or more recipients. The visualization system generates a message request that includes the media content, and one or more of location data identifying a geographical location of the client device, and a timestamp that indicates a time and date of the message requests, but omits persona user information, such as a user's name, names of the recipients of the media content, or any similar private user data. In some embodiments, the message request may comprise only the location data and a timestamp that indicates only the date.

In response to distributing the message request, the visualization system analyzes the media content of the message request to identify one or more tags. Upon detecting a tag, the visualization system compares the tag to a campaign tag database to identify a match. If the visualization system is able to identify a match, the visualization system populates a value matrix that comprises numerical value indicating a number of message requests that contain the tag associated with the campaign, along with location data identifying a location of each of the message requests.

Based on the value matrix, the visualization system generates and presents a visualization of a distribution of the campaign, based on location data from the message requests, in response to detecting the tag associated with the campaign within media content of the message request. The visualization includes a choropleth map that provides an indication of a distribution of message requests that contain the tag via a presentation of a color progression on a map image. In this way, the visualization system may provide a visualization of a distribution of a campaign while maintaining user privacy.

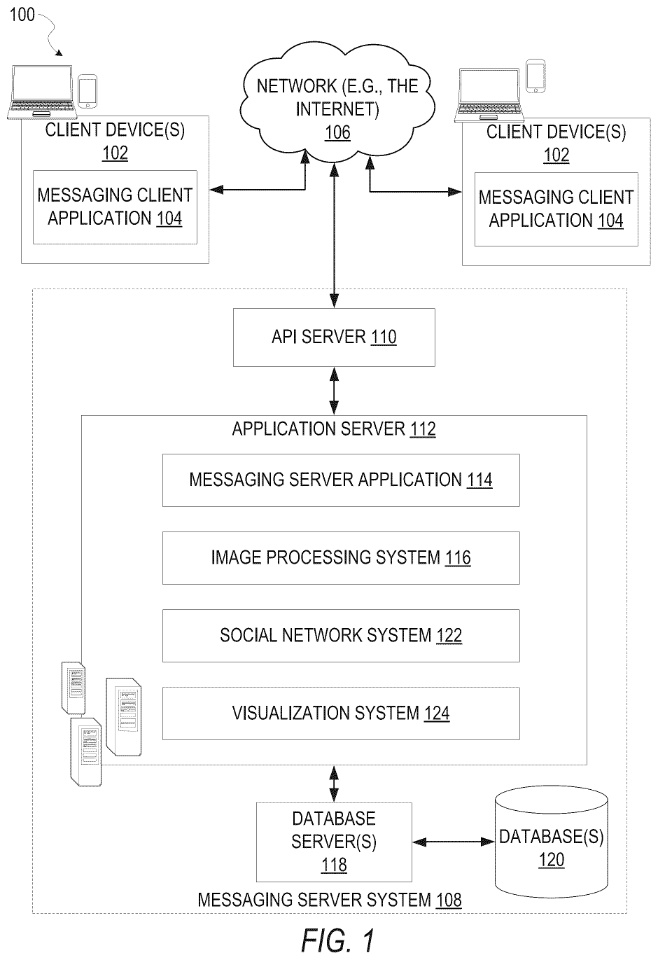

FIG. 1 is a block diagram showing an example messaging system 100 for exchanging data (e.g., messages and associated content) over a network. The messaging system 100 includes multiple client devices 102, each of which hosts a number of applications including a messaging client application 104. Each messaging client application 104 is communicatively coupled to other instances of the messaging client application 104 and a messaging server system 108 via a network 106 (e.g., the Internet).

Accordingly, each messaging client application 104 is able to communicate and exchange data with another messaging client application 104 and with the messaging server system 108 via the network 106. The data exchanged between messaging client applications 104, and between a messaging client application 104 and the messaging server system 108, includes functions (e.g., commands to invoke functions) as well as payload data (e.g., text, audio, video or other multimedia data).

The messaging server system 108 provides server-side functionality via the network 106 to a particular messaging client application 104. While certain functions of the messaging system 100 are described herein as being performed by either a messaging client application 104 or by the messaging server system 108, it will be appreciated that the location of certain functionality either within the messaging client application 104 or the messaging server system 108 is a design choice. For example, it may be technically preferable to initially deploy certain technology and functionality within the messaging server system 108, but to later migrate this technology and functionality to the messaging client application 104 where a client device 102 has a sufficient processing capacity.

The messaging server system 108 supports various services and operations that are provided to the messaging client application 104. Such operations include transmitting data to, receiving data from, and processing data generated by the messaging client application 104. In some embodiments, this data includes, message content, client device information, geolocation information, media annotation and overlays, message content persistence conditions, social network information, and live event information, as examples. In other embodiments, other data is used. Data exchanges within the messaging system 100 are invoked and controlled through functions available via user interfaces (UIs) of the messaging client application 104.

Turning now specifically to the messaging server system 108, an Application Program Interface (API) server 110 is coupled to, and provides a programmatic interface to, an application server 112. The application server 112 is communicatively coupled to a database server 118, which facilitates access to a database 120 in which is stored data associated with messages processed by the application server 112.

Dealing specifically with the Application Program Interface (API) server 110, this server receives and transmits message data (e.g., commands and message payloads) between the client device 102 and the application server 112. Specifically, the Application Program Interface (API) server 110 provides a set of interfaces (e.g., routines and protocols) that can be called or queried by the messaging client application 104 in order to invoke functionality of the application server 112. The Application Program Interface (API) server 110 exposes various functions supported by the application server 112, including account registration, login functionality, the sending of messages, via the application server 112, from a particular messaging client application 104 to another messaging client application 104, the sending of media files (e.g., images or video) from a messaging client application 104 to the messaging server application 114, and for possible access by another messaging client application 104, the setting of a collection of media data (e.g., story), the retrieval of a list of friends of a user of a client device 102, the retrieval of such collections, the retrieval of messages and content, the adding and deletion of friends to a social graph, the location of friends within a social graph, opening and application event (e.g., relating to the messaging client application 104).

The application server 112 hosts a number of applications and subsystems, including a messaging server application 114, an image processing system 116, a social network system 122, and a visualization system 124. The messaging server application 114 implements a number of message processing technologies and functions, particularly related to the aggregation and other processing of content (e.g., textual and multimedia content) included in messages received from multiple instances of the messaging client application 104. As will be described in further detail, the text and media content from multiple sources may be aggregated into collections of content (e.g., called stories or galleries). These collections are then made available, by the messaging server application 114, to the messaging client application 104. Other processor and memory intensive processing of data may also be performed server-side by the messaging server application 114, in view of the hardware requirements for such processing.

The application server 112 also includes an image processing system 116 that is dedicated to performing various image processing operations, typically with respect to images or video received within the payload of a message at the messaging server application 114.

The social network system 122 supports various social networking functions services, and makes these functions and services available to the messaging server application 114. To this end, the social network system 122 maintains and accesses an entity graph within the database 120. Examples of functions and services supported by the social network system 122 include the identification of other users of the messaging system 100 with which a particular user has relationships or is “following,” and also the identification of other entities and interests of a particular user.

The application server 112 is communicatively coupled to a database server 118, which facilitates access to a database 120 in which is stored data associated with messages processed by the messaging server application 114.

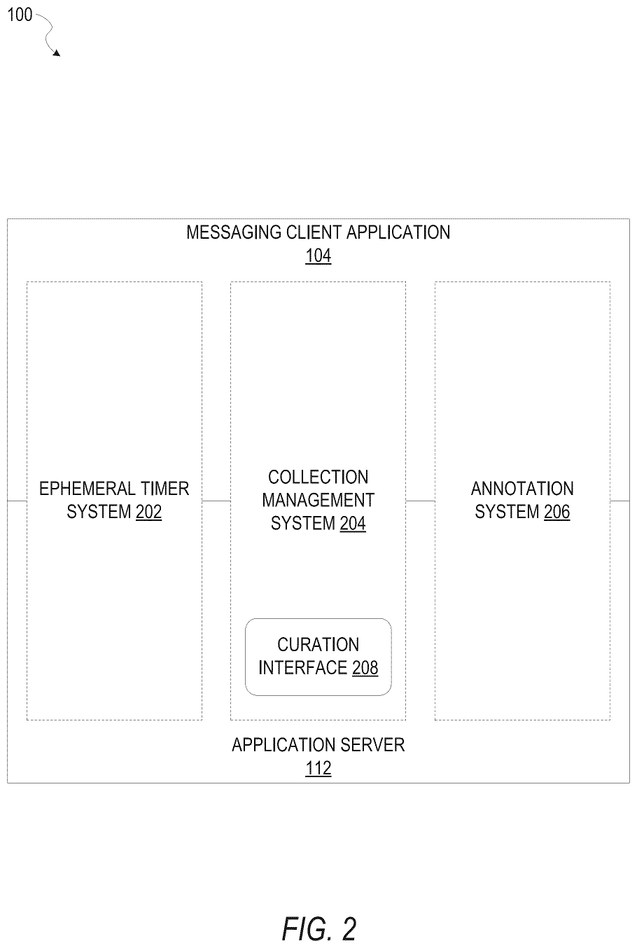

FIG. 2 is block diagram illustrating further details regarding the messaging system 100, according to example embodiments. Specifically, the messaging system 100 is shown to comprise the messaging client application 104 and the application server 112, which in turn embody a number of some subsystems, namely an ephemeral timer system 202, a collection management system 204 and an annotation system 206.

The ephemeral timer system 202 is responsible for enforcing the temporary access to content permitted by the messaging client application 104 and the messaging server application 114. To this end, the ephemeral timer system 202 incorporates a number of timers that, based on duration and display parameters associated with a message, or collection of messages (e.g., a SNAPCHAT story), selectively display and enable access to messages and associated content via the messaging client application 104. Further details regarding the operation of the ephemeral timer system 202 are provided below.

The collection management system 204 is responsible for managing collections of content to be distributed to client devices (e.g., collections of text, image video and audio data). In some examples, a collection of content (e.g., messages, including images, video, text and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client application 104.

The collection management system 204 furthermore includes a curation interface 208 that allows a collection manager to manage and curate a particular collection of content. For example, the curation interface 208 enables an event organizer to curate a collection of content relating to a specific event (e.g., delete inappropriate content or redundant messages). Additionally, the collection management system 204 employs machine vision (or image recognition technology) and content rules to automatically curate a content collection. In certain embodiments, compensation may be paid to a user for inclusion of user generated content into a collection. In such cases, the curation interface 208 operates to automatically make payments to such users for the use of their content.

The annotation system 206 provides various functions that enable a user to annotate or otherwise modify or edit media content associated with a message through the addition or identification of tags associated with publishers or account holders. For example, the annotation system 206 provides functions related to the generation and publishing of media overlays for messages processed by the messaging system 100. The annotation system 206 operatively supplies a media overlay (e.g., a SNAPCHAT filter) to the messaging client application 104 based on a geolocation of the client device 102. In another example, the annotation system 206 operatively supplies a media overlay to the messaging client application 104 based on other information, such as, social network information of the user of the client device 102. A media overlay may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo) at the client device 102. For example, the media overlay including text that can be overlaid on top of a photograph generated taken by the client device 102. In another example, the media overlay includes an identification of a location overlay (e.g., Venice beach), a name of a live event, or a name of a merchant overlay (e.g., Beach Coffee House). In another example, the annotation system 206 uses the geolocation of the client device 102 to identify a media overlay that includes the name of a merchant at the geolocation of the client device 102. The media overlay may include other indicia associated with the merchant. The media overlays may be stored in the database 120 and accessed through the database server 118.

In one example embodiment, the annotation system 206 provides a user-based publication platform that enables users to select a geolocation on a map, and upload content associated with the selected geolocation. The user may also specify circumstances under which a particular media overlay should be offered to other users. The annotation system 206 generates a media overlay that includes the uploaded content and associates the uploaded content with the selected geolocation.

In another example embodiment, the annotation system 206 provides a merchant-based publication platform that enables merchants to select a particular media overlay associated with a geolocation via a bidding process. For example, the annotation system 206 associates the media overlay of a highest bidding merchant with a corresponding geolocation for a predefined amount of time

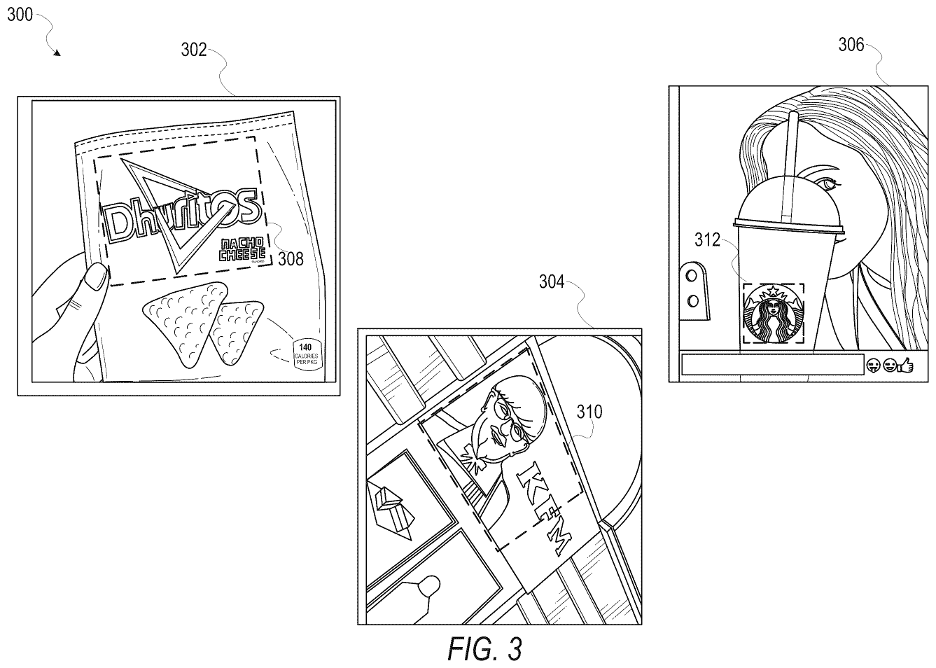

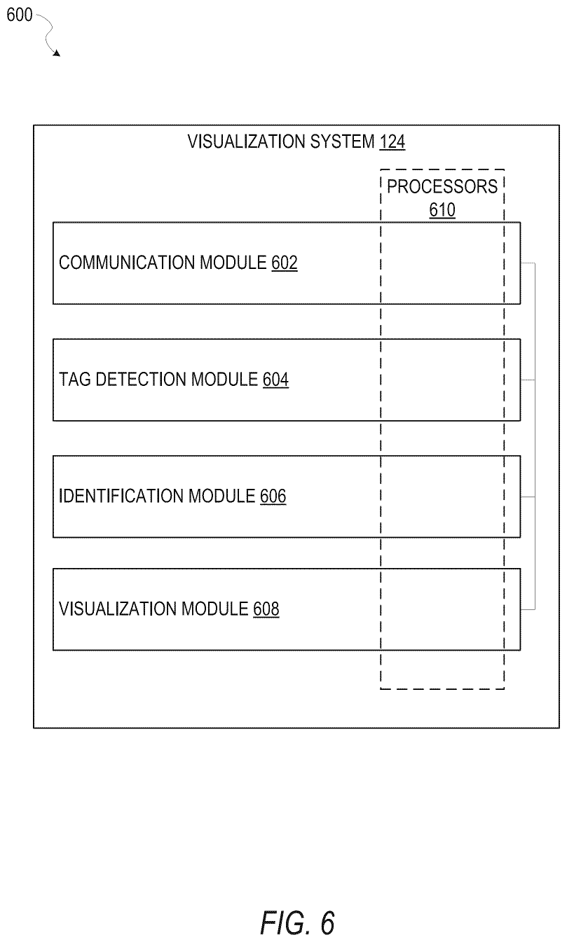

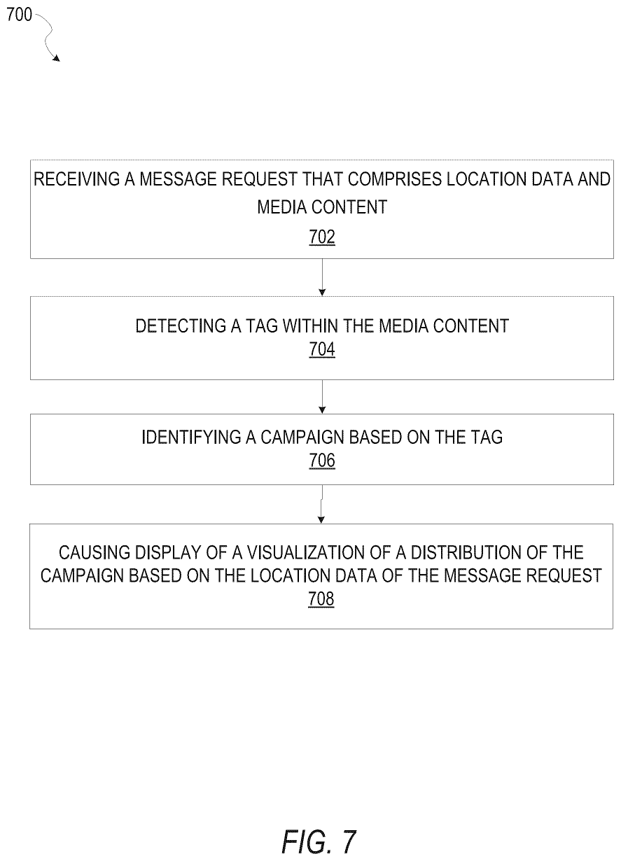

FIG. 3 is a diagram 300 illustrating tags identified in media content identified by a visualization system 124, according to certain example embodiments. The diagram 300 includes depictions of sample media content 302, 304, and 306. The sample media content may for example comprise image data, video data, or animation data. As seen in the diagram 300, the sample media content includes images captured by a user of client device 102 that contain depictions of tags such as company logos (e.g., tag 308, tag 310, and tag 312). The visualization system 124 identifies the tags within the sample media content based on the methods 600 and 700, as seen in FIGS. 6 and 7.

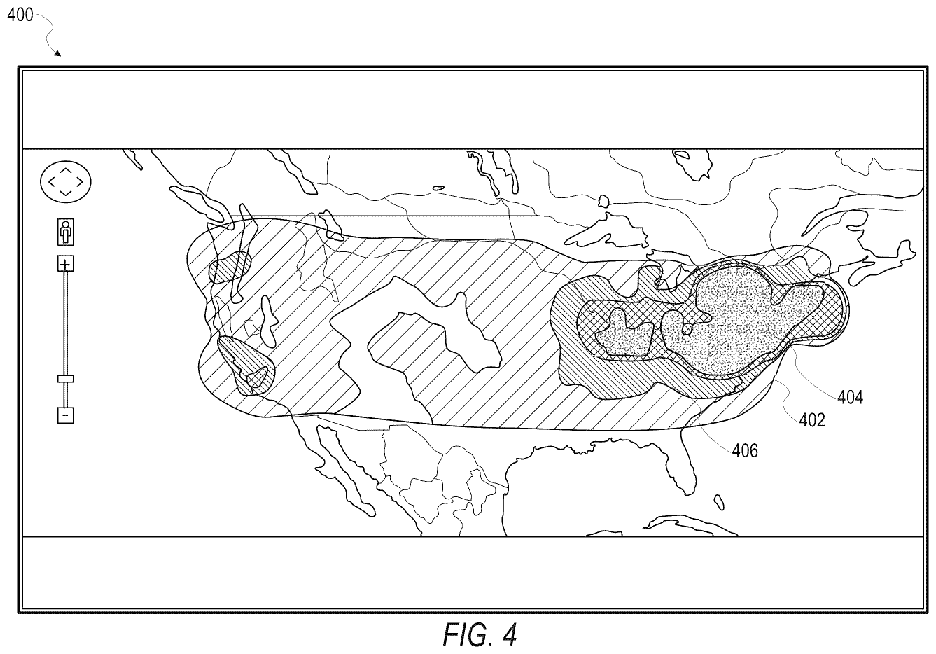

FIG. 4 is a visualization 400 of a distribution of a campaign as presented by a visualization system, according to certain example embodiments. As seen in FIG. 4, the visualization 400 includes a choropleth map 402 that depicts a distribution of a campaign by presenting a color or pattern progression, wherein different shades or pattern correspond to different numerical values representative of a concentration of message requests that contain a tag associated with the campaign. For example, as seen in the visualization 400, the region 404 represents a high concentration of message requests that contain a tag associated with the campaign, while region 406 may represent a lower concentration of message requests that contain the tag associated with the campaign. In some embodiments, the visualization system 124 may generate and maintain geo-fences based on the distribution depicted by the visualization 400.

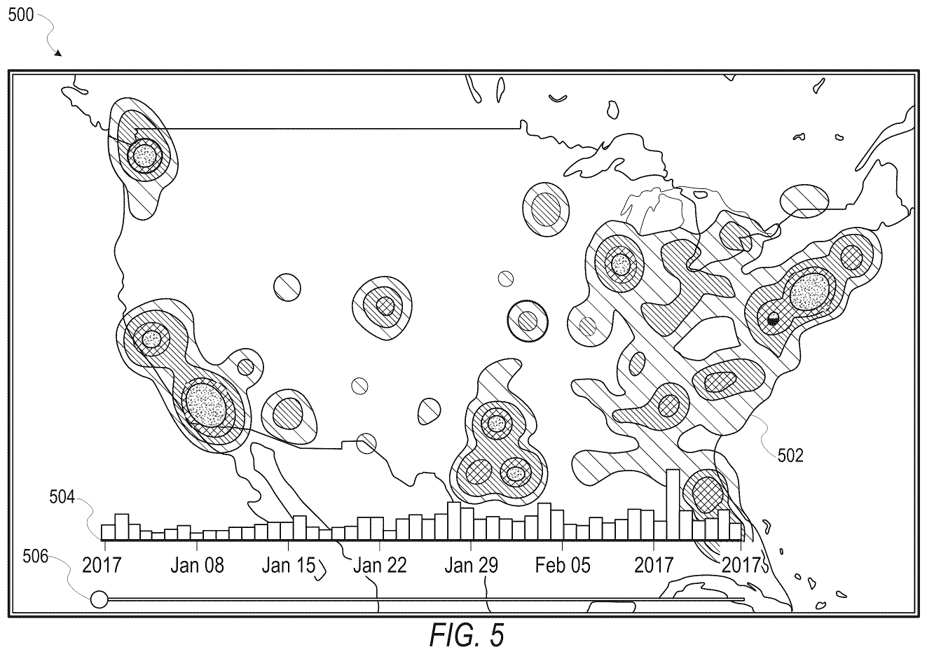

FIG. 5 is a visualization 500 of a geographic distribution 502 of a campaign that also includes a presentation of a temporal distribution 504 of the campaign, as presented by a visualization system 124, according to certain example embodiments. The visualization 500 also includes a slider element 506, wherein the slider element 506 is configured to receive a user input setting a temporal limit/criteria. For example, a user may provide an input moving the slider element 506 to another position along an axis, and in response the visualization system 124 updates the visualization 500.

In some embodiments, a user may provide an input selecting one or more tags, or a campaign, and in response, the visualization system 124 accesses a database to retrieve data indicating a distribution of the selected tags. For example, a user may provide an input specifying a campaign, or a distributor or publisher associated with the campaign (e.g., “Duhrito's”), and in response the visualization system 124 identifies and retrieves relevant data to be displayed in the visualization 500.

FIG. 6 is a block diagram illustrating components of the visualization system 124, that configure the visualization system 124 to receive message requests that comprise location data and media content, detect tags within the media content in response to receiving the message requests, identify a corresponding campaign based on the tags, and generate ad cause display of a visualization of a distribution of the campaign based on the location data of the message request, in response to identifying the campaign based on the tag, according to some example embodiments. The visualization system 124 is shown as including a communication module modules 602, a tag detection module 604, an identification module 606, and a visualization module 608, all configured to communicate with each other (e.g., via a bus, shared memory, or a switch). Any one or more of these modules may be implemented using one or more processors 610 (e.g., by configuring such one or more processors to perform functions described for that module) and hence may include one or more of the processors 610.

Any one or more of the modules described may be implemented using hardware alone (e.g., one or more of the processors 610 of a machine) or a combination of hardware and software. For example, any module described of the visualization system 124 may physically include an arrangement of one or more of the processors 610 (e.g., a subset of or among the one or more processors of the machine) configured to perform the operations described herein for that module. As another example, any module of the visualization system 124 may include software, hardware, or both, that configure an arrangement of one or more processors 610 (e.g., among the one or more processors of the machine) to perform the operations described herein for that module. Accordingly, different modules of the visualization system 124 may include and configure different arrangements of such processors 610 or a single arrangement of such processors 610 at different points in time. Moreover, any two or more modules of the visualization system 124 may be combined into a single module, and the functions described herein for a single module may be subdivided among multiple modules. Furthermore, according to various example embodiments, modules described herein as being implemented within a single machine, database, or device may be distributed across multiple machines, databases, or devices.

FIG. 7 is a flowchart illustrating various operations of a visualization system 124 in performing a method 700 for generating and causing display of a visualization of a distribution of a campaign, according to certain example embodiments, and as depicted in FIG. 4. Operations of the method 700 may be performed by the modules described above with respect to FIG. 6. As shown in FIG. 7, the method 700 includes one or more operations 702, 704, 706, and 708.

At operation 702, the communication module 602 receives a message request having at least location data and media content. For example, the message request may include an ephemeral message transmitted from a client device 102 to one or more recipients, wherein the ephemeral message includes media content such as image data, video data, or audio data. The media content may further comprise a tag, or other similar identifier, wherein the tag identifies a publisher, or campaign associated with a publisher. For example, a tag may include a “hashtag,” or a company logo, barcodes or other similar coded images, text string, or an image associated with a campaign or publisher.

At operation 704, the tag detection module 604 detects a tag within the media content, as seen in FIG. 3, in response to the communication module 602 receiving the message request. In some embodiments, the tag detection module 604 may apply various pattern recognition techniques to detect one or more tags within the media content.

Pattern recognition includes forms of machine learning that focus on the recognition of patterns and regularities in data. The tag detection module 604 may be “trained” through a series of labeled training data, or in some embodiments may apply various algorithms known to those of ordinary skill in the art to discover and identify patterns (e.g., through unsupervised learning).

In further embodiments, the tag detection module 604 may apply Object-based Image Analysis techniques to segment and classify media content, as well as speech or audio recognition techniques. For example, in object recognition, the tag detection module 604 may use edge detection systems to identify points in media content such as digital images and videos at which image brightness changes sharply, or has discontinuities. The points at which the image brightness changes are organized into a set of curved line segments. The curved line segments may thereby be combined and analyzed to identify one or more tags within the media content.

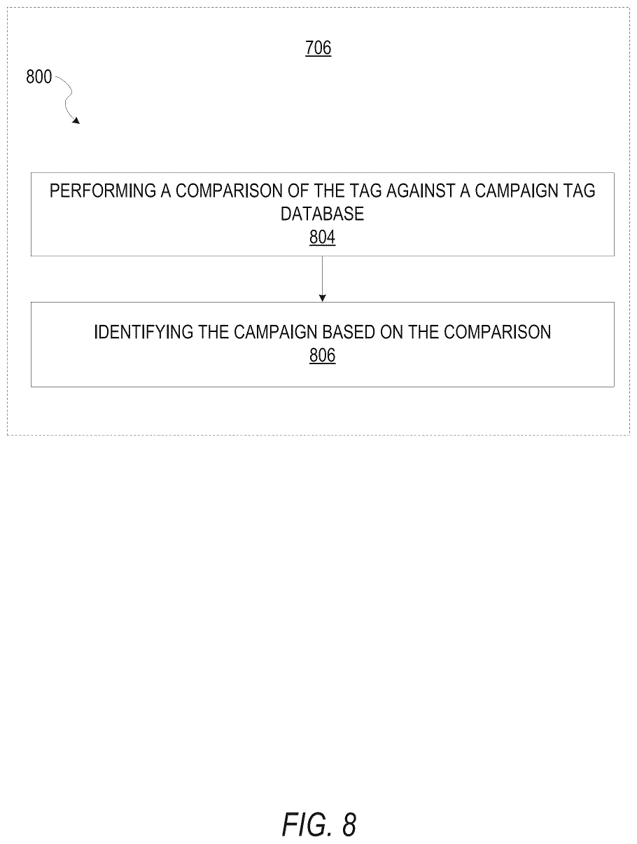

Other forms of feature detection may be used by the tag detection module 604 to identify corners, blobs, or ridges within the media content. Corners may refer to point-like features in media content, which have a local two dimensional structure. Blobs refer to image structures in terms of regions, and may comprise a preferred point (a local maximum of an operator response or a center of gravity). A ridge may include a one-dimensional curve that represents an axis of symmetry, and in addition has an attribute of local ridge width associated with each ridge point. At operation 706, the identification module 606 identifies a campaign based on the tag extracted from the media content by the tag detection module 604. Further details of specific example embodiments that perform operation 706 are depicted in the method 800 of FIG. 8.

At operation 708, the visualization module 608 generates and causes display of a visualization of a distribution of the campaign based on the location data of the message request, in response to the identification module 606 identifying the campaign associated with the tag. In some embodiments, the visualization of the distribution of the campaign may include a presentation of a map image that depicts a region which includes the location identified by the location data, and wherein the visualization includes a presentation of a graphical icon at a position within the map image, wherein the position is based on the location data of the message request. The graphical icon may be based on the campaign associated with the tag. For example, the graphical icon may include a logo, or icon associated with the campaign.

The visualization of the distribution of the campaign may include a presentation of a choropleth map, or heat map, that comprises a map image depicting a distribution of the campaign based on the location data from the message request. The heat map may depict a distribution of message requests that contain media content that includes one or more tags associated with a particular campaign. For example, the visualization of the distribution of the campaign may be depicted by a color progression.

The color progression may include a single-hue progression that fades from a dark shade of a chosen color to a very light shade of the chose color or white, wherein the darkest hue represents the greatest concentration/number value in a data set, and the lightest shade represents the least concentration/number value.

The color progression may include a bi-polar progression to show a change in value from negative to positive or on either side of some central tendency, such as the mean of the variable being mapped (e.g., campaign distribution). For example, a bi-polar progression may range from a dark shade of a first color to a dark shade of a second color, with white applied at the central most value.

The campaign may have campaign parameters that include a start date and an end date, and the message request may also comprise a timestamp indicating a time and date in which the message request was created. The visualization generated and displayed by the visualization module 608 may comprise a depiction of a temporal distribution of message requests that include the tag associated with the campaign, as seen in FIG. 8. For example, the visualization may include a slider element configured to receive a user input to adjust a temporal range. In response to receiving a user input specifying the temporal range, the visualization module 608 may access a database of message requests to retrieve message requests with timestamps within the temporal range defined by the user input. The visualization module 608 may thus alter the presentation of the map image to include a heat map based on the message requests sent within the temporal range.

FIG. 8 is a flowchart illustrating various operations of a visualization system 124 in performing operations of a method 800 for identifying a campaign based on a tag, according to certain example embodiments. Operations of the method 800 may be performed by the modules described above with respect to FIG. 6. As shown in FIG. 8, the method 800 includes one or more operations 802, and 804. In some embodiments, the method 800 may be performed as a sub-routine, or subsequent to, operation 706 of the method 700 of FIG. 7.

At operation 804, the identification module 606 performs a comparison of a tag detected within media content against a campaign tag database (e.g., database 120). For example, a publisher may provide one or more tags to be associated with a campaign to the visualization system 124. The visualization system 124 may index or otherwise store the tags within the campaign tag database, at a memory location associated with the campaign indicated by the publisher. In response to the tag detection module 604 detecting the tag within the media content, the identification module 606 performs a comparison of the detected tag against the one or more tags stored within the campaign tag database. At operation 806, the identification module 606 identifies the campaign (or campaigns) associated with the tag.

In some embodiments, the campaign has the tag, and distribution criteria that include geo-location criteria, as well as a start date and an end date. The distribution of the campaign initiates on the start date and concludes on the end date.

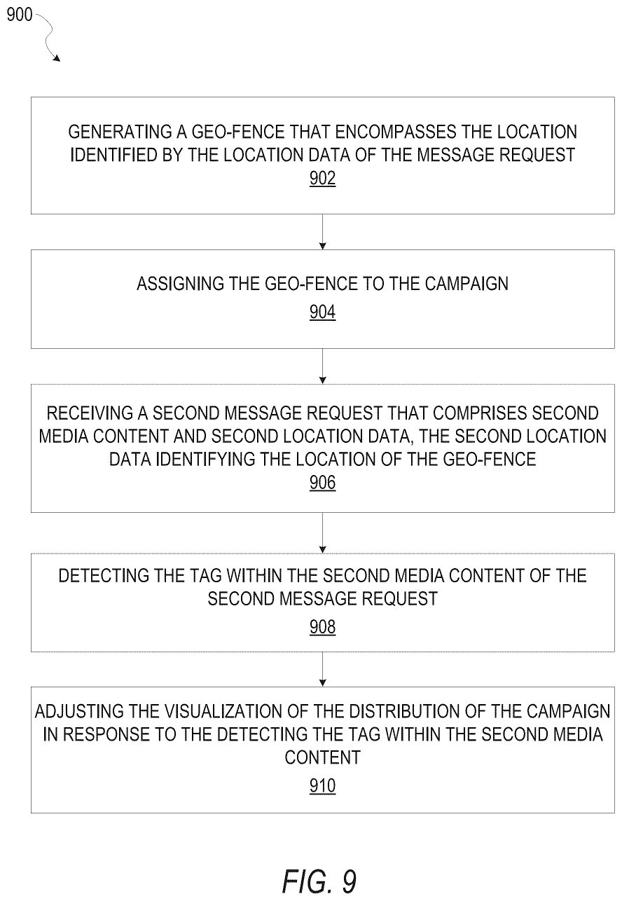

FIG. 9 is a flowchart illustrating various operations of a visualization system 124 in performing a method 900 for adjusting a visualization of a distribution of a campaign, according to certain example embodiments. Operations of the method 900 may be performed by the modules described above with respect to FIG. 6. As shown in FIG. 9, the method 900 includes one or more operations 902, 904, 906, 908, and 910.

At operation 902, the visualization system 124 generates a geo-fence that encompasses a location identified by the location data of the message request received by the communication module 602. A geo-fence is a virtual perimeter for a real-world geographic area that comprises a boundary. The boundary may for example include a circle, or polygonal shape. In some embodiments, the visualization system 124 may determine parameters of the geo-fence based on the distribution of the campaign. For example, the visualization system 124 may alter and adjust a size and shape of the geo-fence based on location data of subsequent message requests. In further embodiments, the visualization system 124 may generate individual geo-fences based on the location data form each message request received, wherein the geo-fence has a predefined size and shape (e.g., 50 m×50 m square, or 50 m radius from a point identified by the location data). At operation 904, the identification module 606 assigns the geo-fence or geo-fences to the campaign associated with the detected tag.

At operation 906, the communication module 602 receives a second message request that comprises second media content and second location data, wherein the second location data identifies the location of the geo-fence. In response to receiving the second message request from within the geo-fence, the tag detection module 604 determines whether or not the second media content of the second message request contains the tag associated with the campaign of the geo-fence.

At operation 910, the visualization module 608 alters and adjusts the visualization of the distribution of the campaign based on a confirmation that the second media content contains the tag associated with the campaign. For example, the visualization module 608 may alter a color progression of a heat map to indicate a greater concentration of message requests that contain the tag associated with the campaign at a location identified by the location data from the message requests.

At operation 902, the distribution module 602 causes display of a notification at a client device 102, wherein the notification includes a request to present the second content. As discussed above with respect to FIGS. 7 and 8, the second content may include a survey comprising one or more questions requesting binary responses. The notification may be displayed as an overlay upon a graphical user interface of the client device 102, such that the notification may be moved or repositioned within the graphical user interface. In some embodiments, the notification may include an indication of the second content (e.g., “Take this quick survey!”). Recipients of the notification may provide a user input to ignore or accept the notification.

In response to receiving a user input to the notification, the distribution module 602 may cause display of the second content (e.g., the survey). For example, the survey may be overlaid over graphical elements within a graphical user interface of the client device 102. The survey may comprise a set of questions related to the first content, wherein the questions include requests for responses. In some example embodiments, the requests may include requests for binary responses.

### Software Architecture

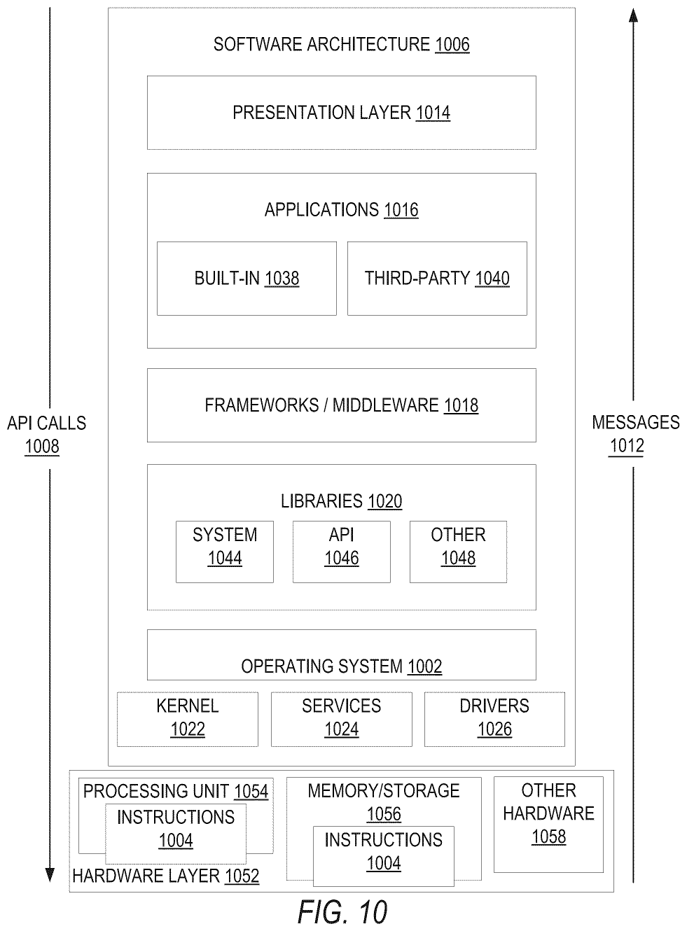

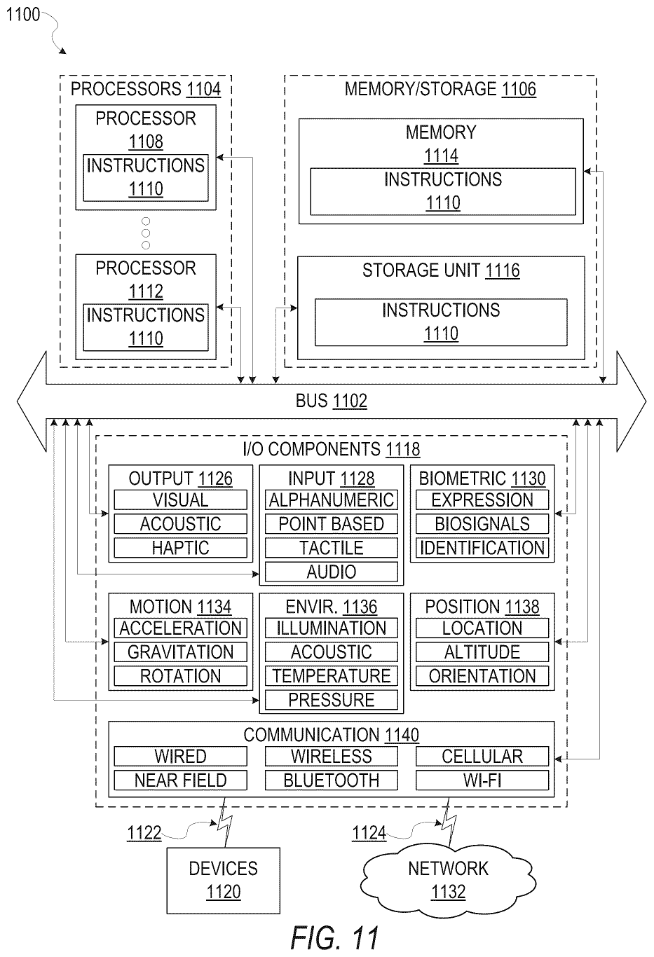

FIG. 10 is a block diagram illustrating an example software architecture 1006, which may be used in conjunction with various hardware architectures herein described. FIG. 10 is a non-limiting example of a software architecture and it will be appreciated that many other architectures may be implemented to facilitate the functionality described herein. The software architecture 1006 may execute on hardware such as machine 1100 of FIG. 11 that includes, among other things, processors 1104, memory 1114, and I/O components 1118. A representative hardware layer 1052 is illustrated and can represent, for example, the machine 1100 of FIG. 11. The representative hardware layer 1052 includes a processing unit 1054 having associated executable instructions 1004. Executable instructions 1004 represent the executable instructions of the software architecture 1006, including implementation of the methods, components and so forth described herein. The hardware layer 1052 also includes memory and/or storage modules memory/storage 1056, which also have executable instructions 1004. The hardware layer 1052 may also comprise other hardware 1058.

In the example architecture of FIG. 10, the software architecture 1006 may be conceptualized as a stack of layers where each layer provides particular functionality. For example, the software architecture 1006 may include layers such as an operating system 1002, libraries 1020, applications 1016 and a presentation layer 1014. Operationally, the applications 1016 and/or other components within the layers may invoke application programming interface (API) calls 1008 through the software stack and receive a response as in response to the API calls 1008. The layers illustrated are representative in nature and not all software architectures have all layers. For example, some mobile or special purpose operating systems may not provide a frameworks/middleware 1018, while others may provide such a layer. Other software architectures may include additional or different layers.

The operating system 1002 may manage hardware resources and provide common services. The operating system 1002 may include, for example, a kernel 1022, services 1024 and drivers 1026. The kernel 1022 may act as an abstraction layer between the hardware and the other software layers. For example, the kernel 1022 may be responsible for memory management, processor management (e.g., scheduling), component management, networking, security settings, and so on. The services 1024 may provide other common services for the other software layers. The drivers 1026 are responsible for controlling or interfacing with the underlying hardware. For instance, the drivers 1026 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1020 provide a common infrastructure that is used by the applications 1016 and/or other components and/or layers. The libraries 1020 provide functionality that allows other software components to perform tasks in an easier fashion than to interface directly with the underlying operating system 1002 functionality (e.g., kernel 1022, services 1024 and/or drivers 1026). The libraries 1020 may include system libraries 1044 (e.g., C standard library) that may provide functions such as memory allocation functions, string manipulation functions, mathematical functions, and the like. In addition, the libraries 1020 may include API libraries 1046 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1020 may also include a wide variety of other libraries 1048 to provide many other APIs to the applications 1016 and other software components/modules.

The frameworks/middleware 1018 (also sometimes referred to as middleware) provide a higher-level common infrastructure that may be used by the applications 1016 and/or other software components/modules. For example, the frameworks/middleware 1018 may provide various graphic user interface (GUI) functions, high-level resource management, high-level location services, and so forth. The frameworks/middleware 1018 may provide a broad spectrum of other APIs that may be used by the applications 1016 and/or other software components/modules, some of which may be specific to a particular operating system 1002 or platform.

The applications 1016 include built-in applications 1038 and/or third-party applications 1040. Examples of representative built-in applications 1038 may include, but are not limited to, a contacts application, a browser application, a book reader application, a location application, a media application, a messaging application, and/or a game application. Third-party applications 1040 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 1040 may invoke the API calls 1008 provided by the mobile operating system (such as operating system 1002) to facilitate functionality described herein.

The applications 1016 may use built in operating system functions (e.g., kernel 1022, services 1024 and/or drivers 1026), libraries 1020, and frameworks/middleware 1018 to create user interfaces to interact with users of the system. Alternatively, or additionally, in some systems interactions with a user may occur through a presentation layer, such as presentation layer 1014. In these systems, the application/component “logic” can be separated from the aspects of the application/component that interact with a user. FIG. 11 is a block diagram illustrating components of a machine 1100, according to some example embodiments, able to read instructions from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1110 (e.g., software, a program, an application, an applet, an app, or other executable code) for causing the machine 1100 to perform any one or more of the methodologies discussed herein may be executed. As such, the instructions 1110 may be used to implement modules or components described herein. The instructions 1110 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1110, sequentially or otherwise, that specify actions to be taken by machine 1100. Further, while only a single machine 1100 is illustrated, the term “machine” shall also be taken to include a collection of machines that individually or jointly execute the instructions 1110 to perform any one or more of the methodologies discussed herein.

The machine 1100 may include processors 1104, memory memory/storage 1106, and I/O components 1118, which may be configured to communicate with each other such as via a bus 1102. The memory/storage 1106 may include a memory 1114, such as a main memory, or other memory storage, and a storage unit 1116, both accessible to the processors 1104 such as via the bus 1102. The storage unit 1116 and memory 1114 store the instructions 1110 embodying any one or more of the methodologies or functions described herein. The instructions 1110 may also reside, completely or partially, within the memory 1114, within the storage unit 1116, within at least one of the processors 1104 (e.g., within the processor's cache memory), or any suitable combination thereof, during execution thereof by the machine 1100. Accordingly, the memory 1114, the storage unit 1116, and the memory of processors 1104 are examples of machine-readable media.

The I/O components 1118 may include a wide variety of components to receive input, provide output, produce output, transmit information, exchange information, capture measurements, and so on. The specific I/O components 1118 that are included in a particular machine 1100 will depend on the type of machine. For example, portable machines such as mobile phones will likely include a touch input device or other such input mechanisms, while a headless server machine will likely not include such a touch input device. It will be appreciated that the I/O components 1118 may include many other components that are not shown in FIG. 11. The I/O components 1118 are grouped according to functionality merely for simplifying the following discussion and the grouping is in no way limiting. In various example embodiments, the I/O components 1118 may include output components 1126 and input components 1128. The output components 1126 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1128 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1118 may include biometric components 1130, motion components 1134, environmental components 1136, or position components 1138 among a wide array of other components. For example, the biometric components 1130 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1134 may include acceleration sensor components (e.g., accelerometer), gravitation sensor components, rotation sensor components (e.g., gyroscope), and so forth. The environment components 1136 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1138 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1118 may include communication components 1140 operable to couple the machine 1100 to a network 1132 or devices 1120 via coupling 1122 and coupling 1124 respectively. For example, the communication components 1140 may include a network interface component or other suitable device to interface with the network 1132. In further examples, communication components 1140 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1120 may be another machine or any of a wide variety of peripheral devices (e.g., a peripheral device coupled via a Universal Serial Bus (USB)).

Moreover, the communication components 1140 may detect identifiers or include components operable to detect identifiers. For example, the communication components 1140 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1140, such as, location via Internet Protocol (IP) geo-location, location via Wi-Fi® signal triangulation, location via detecting a NFC beacon signal that may indicate a particular location, and so forth.

### GLOSSARY

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“EMPHEMERAL MESSAGE” in this context refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

“LIFT” in this context is a measure of the performance of a targeted model at predicting or classifying cases as having an enhanced response (with respect to a population as a whole), measured against a random choice targeting model.

What is claimed is:

1. A method comprising:
receiving a request that includes a tag, the tag corresponding with a campaign that comprises parameters that include a start date and an end date;
accessing data that corresponds with the campaign from within a repository, the data comprising location data and temporal data;
generating a distribution of message requests that contain the tag based on the temporal data and the location data;
causing display of a visualization associated with the campaign, the visualization defining at least one boundary that encompasses locations identified by the location data;
receiving a second request that comprises second location data;
determining that the second location data identifies a location within the at least one boundary; and
updating the visualization of the distribution of the campaign based on the second request.

2. The method of claim 1, wherein the visualization comprises a choropleth map.

3. The method of claim 1, wherein the tag comprises one or more of:
an image;
a hashtag;
a graphical element; and
an auditory element.

4. The method of claim 1, wherein the at least one boundary comprises a geo-fence that encompasses a geographic region identified by the location data.

5. The method of claim 1, wherein the causing display of the visualization includes:
causing display of a map image that depicts a region that includes locations identified by the location data; and
presenting the at least one boundary as a graphical overlay within the map image.

6. The method of claim 5, wherein the graphical overlay corresponds with the tag.

7. The method of claim 1, wherein the accessing the data that corresponds with the campaign includes:
performing a comparison of the tag to a tag database; and
identifying the data based on the comparison.

8. A system comprising:
a memory; and
at least one hardware processor coupled to the memory and comprising instructions that causes the system to perform operations comprising:
receiving a request that includes a tag, the tag corresponding with a campaign that comprises parameters that include a start date and an end date;
accessing data that corresponds with the campaign from within a repository, the data comprising location data and temporal data;
generating a distribution of message requests that contain the tag based on the temporal data and the location data;
causing display of a visualization associated with the campaign, the visualization defining at least one boundary that encompasses locations identified by the location data;
receiving a second request that comprises second location data;
determining that the second location data identifies a location within the at least one boundary; and
updating the visualization of the distribution of the campaign based on the second request.

9. The system of claim 8, wherein the visualization comprises a choropleth map.

10. The system of claim 8, wherein the tag comprises one or more of:
an image;
a hashtag;
a graphical element; and
an auditory element.

11. The system of claim 8, wherein the at least one boundary comprises a geo-fence that encompasses a geographic region identified by the location data.

12. The system of claim 8, wherein the causing display of the visualization includes:
causing display of a map image that depicts a region that includes locations identified by the location data; and
presenting the at least one boundary as a graphical overlay within the map image.

13. The system of claim 12, wherein the graphical overlay corresponds with the tag.

14. The system of claim 8, wherein the accessing the data that corresponds with the campaign includes:
performing a comparison of the tag to a tag database; and
identifying the data based on the comparison.

15. A non-transitory machine-readable storage medium comprising instructions that, when executed by one or more processors of a machine, cause the machine to perform operations comprising:
receiving a request that includes a tag, the tag corresponding with a campaign that comprises parameters that include a start date and an end date;
accessing data that corresponds with the campaign from within a repository, the data comprising location data and temporal data;
generating a distribution of message requests that contain the tag based on the temporal data and the location data;
causing display of a visualization associated with the campaign, the visualization defining at least one boundary that encompasses locations identified by the location data;
receiving a second request that comprises second location data;
determining that the second location data identifies a location within the at least one boundary; and
updating the visualization of the distribution of the campaign based on the second request.

16. The non-transitory machine-readable storage medium of claim 15, wherein the visualization comprises a choropleth map.

17. The non-transitory machine-readable storage medium of claim 15, wherein the tag comprises one or more of:
an image;
a hashtag;
a graphical element; and
an auditory element.

18. The non-transitory machine-readable storage medium of claim 15, wherein the at least one boundary comprises a geo-fence that encompasses a geographic region identified by the location data.

19. The non-transitory machine-readable storage medium of claim 15, wherein the causing display of the visualization includes:
causing display of a map image that depicts a region that includes locations identified by the location data; and
presenting the at least one boundary as a graphical overlay within the map image.

20. The non-transitory machine-readable storage medium of claim 19, wherein the graphical overlay corresponds with the tag.
